(19) United States
(12) Patent Application Publication
(10) Pub. No.: US 2025/0191205 A1
(43) Pub. Date: Jun. 12, 2025

(54) MULTI-OBJECT TRACKING WITH DYNAMIC FEATURE EXTRACTION AND FUSION

(71) Applicant: QUALCOMM Incorporated, San Diego, CA (US)

(72) Inventors: Leulseged Tesfaye ALEMU, San Diego, CA (US); Dashan GAO, San Diego, CA (US); Yen-Hao CHIAO, Kaohsiung City (TW); Jiancheng LYU, San Diego, CA (US)

(21) Appl. No.: 18/620,582

(22) Filed: Mar. 28, 2024

Related U.S. Application Data
(60) Provisional application No. 63/609,245, filed on Dec. 12, 2023.

(51) Int. Cl. G06T 7/50; G06V 10/46; G06V 10/75; G06V 20/40

(52) U.S. Cl. CPC G06T 7/50; G06V 10/46; G06V 10/751; G06V 20/46

(57) ABSTRACT

Techniques and systems are provided for shape estimation. For instance, a process can include determining a first adjacency overlap (AdO) score of a first detected object in a first frame based on overlap between the first detected object and a second detected object in the first frame; and extracting features of the first detected object based on a comparison of the AdO score and a threshold AdO score.

### CROSS REFERENCE TO RELATED APPLICATIONS

The present application claims the benefit of U.S. Provisional Application No. 63/609,245, filed on Dec. 12, 2023, which is hereby incorporated by reference, in its entirety and for all purposes.

### FIELD

The present disclosure generally relates to object tracking. For example, aspects of the present disclosure are related to systems and techniques for a robust multi-object tracking with dynamic feature extraction and fusion.

### BACKGROUND

Systems and devices (e.g., autonomous vehicles, such as autonomous and semi-autonomous cars, drones, mobile robots, mobile devices, extended reality (XR) devices, and other suitable systems or devices) can include multiple sensors to capture information about the environment, as well as processing systems to process the captured information. The captured information can be used for various purposes, such as for virtualization of the environment, virtual object interactions with real objects, route planning, navigation, collision avoidance, etc.

In such systems, sensor data, such as images captured from one or more camera(s), may be captured, transformed, and analyzed to detect objects (e.g., people, animals, vehicles, etc.). In some cases, such systems attempt to detect multiple objects in an environment and perform multi-object tracking (MOT) to track how the objects move through the environment. Generally, MOT tracking is performed by detecting an object in a frame and comparing the detected object to previous frames to associate the detected object with previously detected objects. Existing MOT techniques may perform this association in different ways. However, existing MOT techniques may have issues with noisy feature extraction, such as with overlapping adjacent objects, including background objects/information, ambiguous objects, and/or use heavy backbone networks or heavy computations. Improved techniques for MOT may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, an apparatus for shape is provided. The apparatus includes at least one memory and at least one processor coupled to the at least one memory. The at least one processor may determine a first adjacency overlap (AdO) score of a first detected object in a first frame based on overlap between the first detected object and a second detected object in the first frame; and extract features of the first detected object based on a comparison of the AdO score and a threshold AdO score.

As another example, a method for shape estimation is provided. The method includes: determining a first adjacency overlap (AdO) score of a first detected object in a first frame based on overlap between the first detected object and a second detected object in the first frame; and extracting features of the first detected object based on a comparison of the AdO score and a threshold AdO score.

In another example, a non-transitory computer-readable medium having stored thereon instructions is provided. The instructions, when executed by at least one processor may cause the at least one processor to determine a first adjacency overlap (AdO) score of a first detected object in a first frame based on overlap between the first detected object and a second detected object in the first frame; and extract features of the first detected object based on a comparison of the AdO score and a threshold AdO score.

As another example, an apparatus is provided. The apparatus includes means for determining a first adjacency overlap (AdO) score of a first detected object in a first frame based on overlap between the first detected object and a second detected object in the first frame; and means for extracting features of the first detected object based on a comparison of the AdO score and a threshold AdO score.

In some aspects, one or more of the apparatuses described herein is, is part of, and/or includes a vehicle or a computing device or component of a vehicle (e.g., an autonomous vehicle), a camera, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, or other device. In some aspects, the apparatus(es) includes a camera or multiple cameras for capturing one or more images. In some aspects, the apparatus(es) further includes a display for displaying one or more images, notifications, and/or other displayable data. In some aspects, the apparatus(es) can include one or more sensors (e.g., one or more inertial measurement units (IMUs), such as one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an architecture of an image capture and processing system, in accordance with aspects of the present disclosure;

FIG. 2A is a diagram illustrating an example of a fully-connected neural network, in accordance with some examples of the present disclosure;

FIG. 2B is a diagram illustrating an example of a locally-connected neural network, in accordance with some examples of the present disclosure;

FIG. 2C is a diagram illustrating an example of a convolutional neural network, in accordance with some examples of the present disclosure;

FIG. 2D is a diagram illustrating an example of a deep convolutional network (DCN) for recognizing visual features from an image, in accordance with some examples of the present disclosure;

FIG. 3 is a block diagram illustrating an example deep convolutional network (DCN), in accordance with some examples of the present disclosure;

FIG. 4 is a block diagram illustrating an example of a video analytics system;

FIG. 5 is a block diagram illustrating a robust MOT with dynamic feature extraction and fusion by an object tracking system; in accordance with aspects of the present disclosure;

FIG. 6A is a conceptual diagram illustrating overlapping bounding boxes, in accordance with aspects of the present disclosure;

FIG. 6B is an example of Adjacency Overlap (AdO), in accordance with aspects of the present disclosure;

FIG. 7 is block diagram illustrating track initialization, in accordance with aspects of the present disclosure;

FIG. 8 is a block diagram illustrating association ambiguity, in accordance with aspects of the present disclosure;

FIG. 9A and FIG. 9B illustrate techniques for dynamic feature extraction and fusion, in accordance with aspects of the present disclosure;

FIG. 10 illustrates scale guided feature similarity matching, in accordance with aspect of the present disclosure;

FIG. 11 is a flow diagram illustrating a process for object tracking, in accordance with aspects of the present disclosure; and

FIG. 12 illustrates an example computing device architecture of an example computing device which can implement techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Object detection may be performed to detect objects and locations of detected objects within a frame. These detected objects may then be tracked. In some cases, to track an object a detected object may be matched (e.g., associated) with a previously tracked object. For example, an object tracking system may attempt to associate detected objects with a previously assigned tracker ID of a previously detected object to track multiple objects from frame to frame. Multi-object tracking (MOT) from frame to frame may be challenging due to partial or full occlusion, object disappearance and reappearance, and background changes (e.g., clutter), etc.

Systems, apparatuses, electronic devices, methods (also referred to as processes), and computer-readable media (collectively referred to herein as “systems and techniques”) are described herein for multi-object tracking. In some aspects, a frame representing an environment may be obtained, for example, using a camera(s), lidar, radar, or other sensing device. The frame may be processed, for example, to detect objects in the frame. The detected objects may be processed to perform tracking of the objects. In some cases, an adjacency overlap score may be determined to figure out if a first detected object overlaps with a second detected object. If the first detected objects is sufficiently overlapped/overlaps the second detected object, features may not be extracted for the first detected object. A track may be initialized for the first detected object if the first detected is not qualified for feature extraction and if the first detected object does not match with a track and/or tracklet of a previously detected object.

In some cases, such as where a detected object is eligible for feature extraction, distances may be determined between a location the detected object and predicted locations of previously tracked objects. If the distances between a location of the detected object and predicted locations are above a threshold distance, then feature extraction may not be performed for the detected object and the detected object may not be associated with previously tracked objects based on a comparison of the location of detected object and predicted locations of previously tracked objects. If the distances between the location of the detected object and predicted locations for two or more tracked objects are within a distance threshold, then feature extraction may be performed for the detected object. The features of the detected object may then be compared to features of the tracked objects that are within the distance threshold of the detected object to determine whether the detected object should be associated with the tracked objects.

The systems and techniques describe herein can be used to improve multi-object tracking for objects that may be occluded for various applications and systems, including autonomous or semi-autonomous driving, XR systems, robotics systems, scene understanding, among others.

Various aspects of the application will be described with respect to the figures.

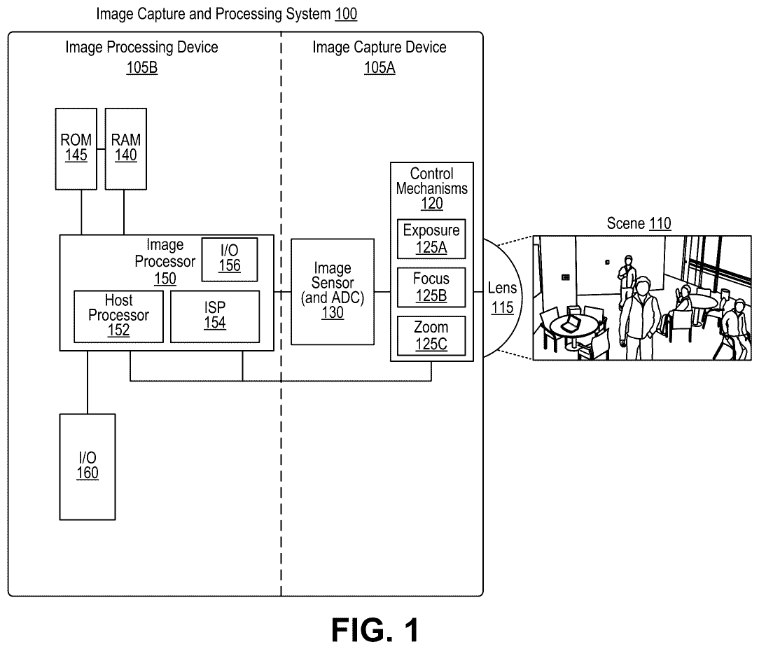

The systems and techniques described herein may be implemented by any type of system or device. FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more micro-lenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a bandpass filter, lowpass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

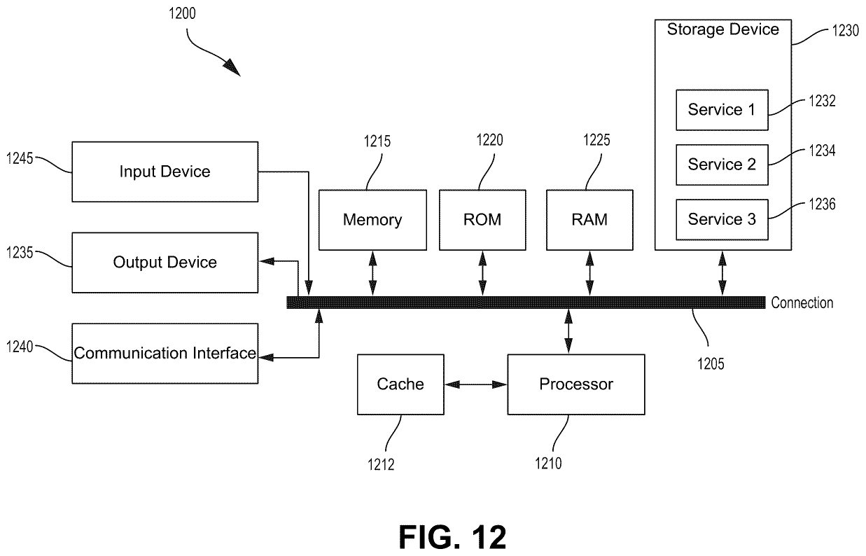

The image processor 150 may include one or more processors, such as one or more image signal processors (ISPs) (including ISP 154), one or more host processors (including host processor 152), and/or one or more of any other type of processor 1010 discussed with respect to the computing system 1200 of FIG. 12. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as demosaicing, color space conversion, image frame down-sampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.10 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

In some cases, images captured by the image capture and processing system 100 may be processed by neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

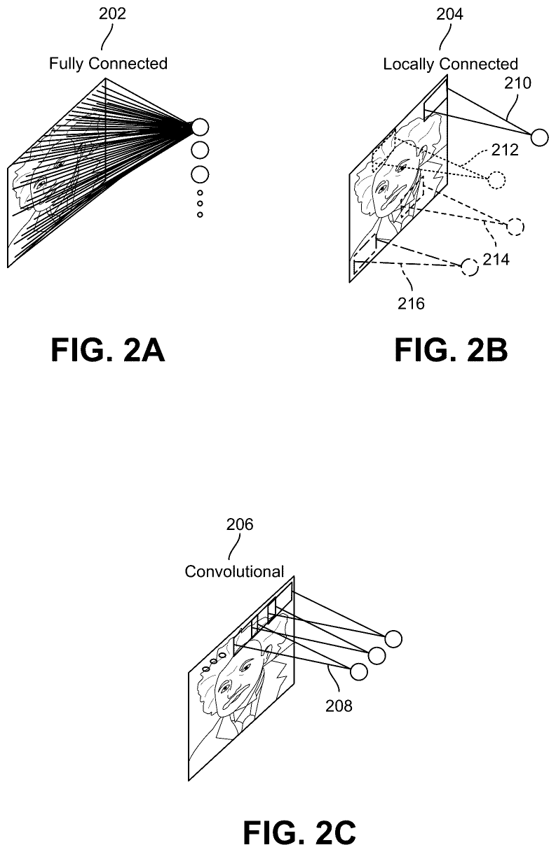

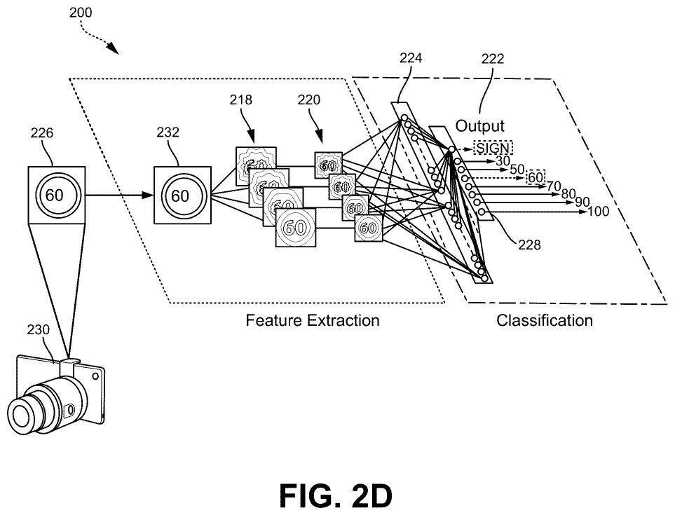

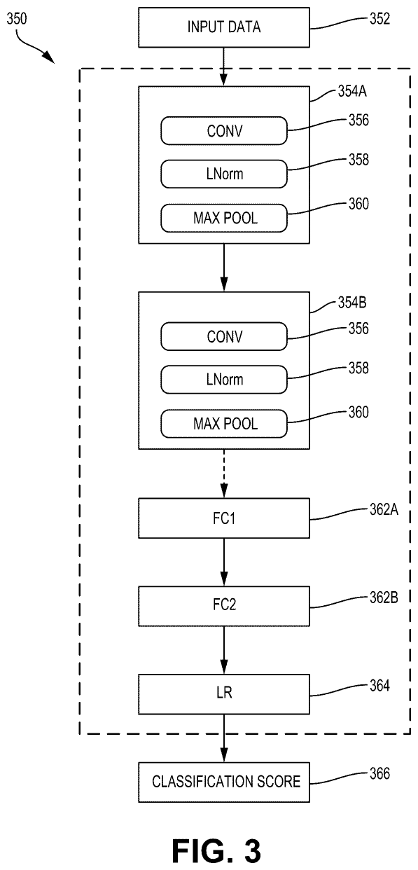

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure.

One type of convolutional neural network is a deep convolutional network (DCN). FIG. 2D illustrates a detailed example of a DCN 200 designed to recognize visual features from an image 226 input from an image capturing device 230, such as a image capture and processing system 100 of FIG. 1. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Of note, the layers illustrated with respect to convolution blocks 354A and 354B are examples of layers that may be included in a convolution layer and are not intended to be limiting and other types of layers may be included in any order.

The convolution layers 356 may include one or more convolutional filters, which may be applied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a processor such as a CPU or GPU, or any other type of processor 1210 discussed with respect to the computing system 1200 of FIG. 12 to achieve high performance and low power consumption. In alternative aspects, the parallel filter banks may be loaded on a DSP or an ISP of the computing system 1200 of FIG. 12. In addition, the deep convolutional network 350 may access other processing blocks that may be present on the computing system 1200 of FIG. 12, such as sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 350 may then be modified to extract (e.g., output) certain features. Additionally, DCNs may be added to extract other features as well. This set of DCNs may function as feature extractors to identify features in an image. In some cases, feature extractors may be used as a backbone for additionally ML network components to perform further operations, such as image segmentation.

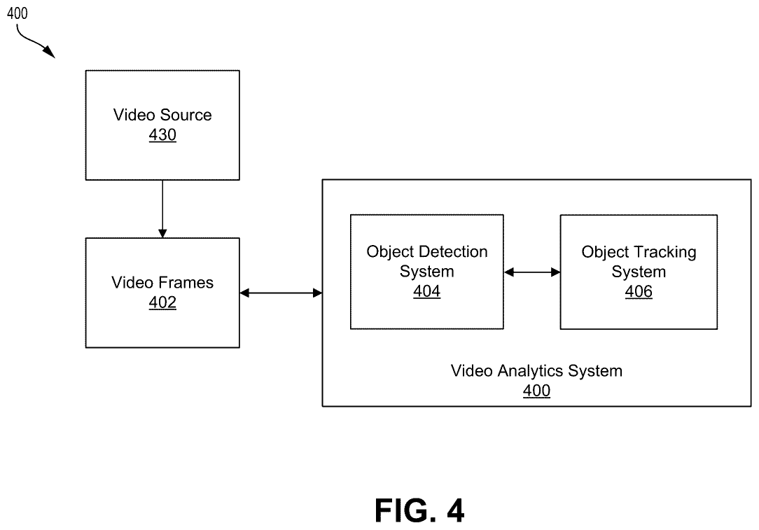

FIG. 4 is a block diagram illustrating an example of a video analytics system 400. In the video analytics system 400, video frames 402 may be received from a video source 430. The video frames 402 can also be referred to herein as a sequence of frames. Each frame of the video frames 402 can also be referred to as a video picture, image, or a picture. The video frames 402 can be part of one or more video sequences. The video source 430 can include an image capture device (e.g., the image capture and processing system 100, a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 430 can include an IP camera or multiple IP cameras. In an illustrative example, multiple IP cameras can be located throughout an environment, and can provide the video frames 402 to the video analytics system 400. For instance, the IP cameras can be placed at various fields of view within the environment so that surveillance can be performed based on the captured video frames 402 of the environment.

In some embodiments, the video analytics system 400 and the video source 430 can be part of the same computing device. In some embodiments, the video analytics system 400 and the video source 430 can be part of separate computing devices. In some examples, the computing device (or devices) can include one or more wireless transceivers for wireless communications. The computing device (or devices) can include an electronic device, such as a camera (e.g., an IP camera or other video camera, a camera phone, a video phone, or other suitable capture device), a mobile or stationary telephone handset (e.g., smartphone, cellular telephone, or the like), a desktop computer, a laptop or notebook computer, a tablet computer, a set-top box, a television, a display device, a digital media player, a video gaming console, a video streaming device, or any other suitable electronic device.

The video analytics system 400 includes an object detection system 404 and an object tracking system 406. Object detection and tracking allows the video analytics system 400 to provide various end-to-end features, such as intelligent motion detection and tracking, intrusion detection, object avoidance, virtual interactions, and other features can directly use the results from object detection and tracking to generate end-to-end events. Other features, such as people, vehicle, or other object counting and classification can be greatly simplified based on the results of object detection and tracking. The object detection system 404 can detect one or more objects in video frames (e.g., video frames 402) of a video sequence, and the object tracking system 406 can track the one or more detected objects across the frames of the video sequence.

As used herein, an object refers to foreground pixels of at least a portion of an object (e.g., a portion of an object or an entire object) in a video frame. For example, an object can include a contiguous group of pixels making up at least a portion of a foreground object in a video frame. In another example, an object can refer to a contiguous group of pixels making up at least a portion of a background object in a frame of image data. An object can also be referred to as a portion of an object, a blotch of pixels, a pixel patch, a cluster of pixels, a blot of pixels, a spot of pixels, a mass of pixels, or any other term referring to a group of pixels of an object or portion thereof. In some examples, a bounding region can be associated with an object. In some examples, a tracker can also be represented by a tracker bounding region. A bounding region of an object or tracker can include a bounding box, a bounding circle, a bounding ellipse, or any other suitably-shaped region representing a tracker and/or an object. While examples are described herein using bounding boxes for illustrative purposes, the techniques and systems described herein can also apply using other suitably shaped bounding regions. A bounding box associated with a tracker and/or an object can have a rectangular shape, a square shape, or other suitable shape. For tracking, in case there is no need to know how the object is formulated within a bounding box, the term object and bounding box may be used interchangeably.

As described in more detail below, objects can be tracked using object trackers. An object track for an object can be associated with a tracker bounding box and a tracked object can be assigned a tracker identifier (ID). In some examples, a bounding box for an object in a current frame can be based on the bounding box of a previously detected object in a previous frame. For instance, when the object track is updated in the previous frame (after being associated with the previous object in the previous frame), updated information for the object track can include the tracking information for the previous frame and also one or more predictions for locations of the object in the next frame (which is the current frame in this example). The prediction of the location of the object in the current frame can be based on the location of the object in the previous frame. In some cases, a history or motion model can be maintained for an object track, including a history of various states, a history of the velocity, and a history of location, of continuous frames, for the object track, as described in more detail below.

In some examples, a motion model for an object track can determine and maintain two or more locations of the object for each frame. For example, a first location for an object for a current frame can include a predicted location for the object in the current frame. The first location is referred to herein as the predicted location. The predicted location of the object in the current frame may include/refer to a location of the object in a previous frame (e.g., based on a history or motion model of the object track). Hence, the location of the object associated with the object track in the previous frame can be used as the predicted location of the object and/or object track in the current frame. A second location for the object for the current frame can include a location in the current frame of the object the object track is associated with in the current frame. The second location is referred to herein as the actual location. Accordingly, the location in the current frame of the object associated with the object track is used as the actual location for the object track in the current frame. The actual location of the object track in the current frame can be used as the predicted location for the object/object track in a next frame. The location of the objects can include the locations of the bounding boxes of the objects.

The velocity of an object track can include the displacement of an object track between consecutive frames. For example, the displacement can be determined between the centers (or centroids) of two bounding boxes for the object track in two consecutive frames. In one illustrative example, the velocity of an object track can be defined as Vₜ=Cₜ−Cₜ₋₁, where Cₜ−Cₜ₋₁=(Cₜₓ−Cₜ₋₁ₓ, C_{ty}−C_{t-1y}). The term Cₜ(Cₜₓ, C_{ty}) denotes the center position of a bounding box of the object track in a current frame, with Cₜₓ being the x-coordinate of the bounding box, and C_{ty} being the y-coordinate of the bounding box. The term Cₜ₋₁(Cₜ₋₁ₓ, C_{t-1y}) denotes the center position (x and y) of a bounding box of the tracker in a previous frame. In some implementations, it is also possible to use four parameters to estimate x, y, width, height at the same time. In some cases, because the timing for video frame data is constant or at least not dramatically different over time (e.g., according to the frame rate, such as 30 frames per second, 60 frames per second, 120 frames per second, or other suitable frame rate), a time variable may not be needed in the velocity calculation. In some cases, a time constant can be used (according to the instant frame rate) and/or a timestamp can be used.

As indicated above, the object tracking system 406 may attempt to associate a detected object with a previously assigned tracker ID to track an object from frame to frame. In some cases, the object tracking system 406 may attempt to track multiple objects in a frame across multiple frames. In some cases, tracking multiple objects (e.g., multiple object tracking (MOT)) may present additional challenges as compared to tracking a single target. For example, where multiple objects are tracked, the tracked objects may be partially or fully occluded with objects potentially disappearing and reappearing along with background changes, irregular motion and other such issues may make it difficult for the object tracking system 406 to match the tracked objects with previously tracked objects/object tracks across such situations. For example, existing tracking-by-detection approaches, such as motion, intersection over union (IOU), re-identification (ReID), etc. may fail in crowded scenes and/or scenes with irregular motion as such systems may not be able to separate features from multiple objects (or background) with overlapping bounding boxes, lack an ability to preserve long-term temporal information for handling objects which become occluded, and/or handle objects which move in unpredictable ways. Other techniques for MOT, such as segmentation-based, transformer-based, and tracklet-linking based techniques may not be suitable for real-time and/or edge-based operations as such solutions may have heavy computational requirements and/or large backbone networks. In some cases, MOT may be improved using a robust MOT with dynamic feature extraction and fusion technique.

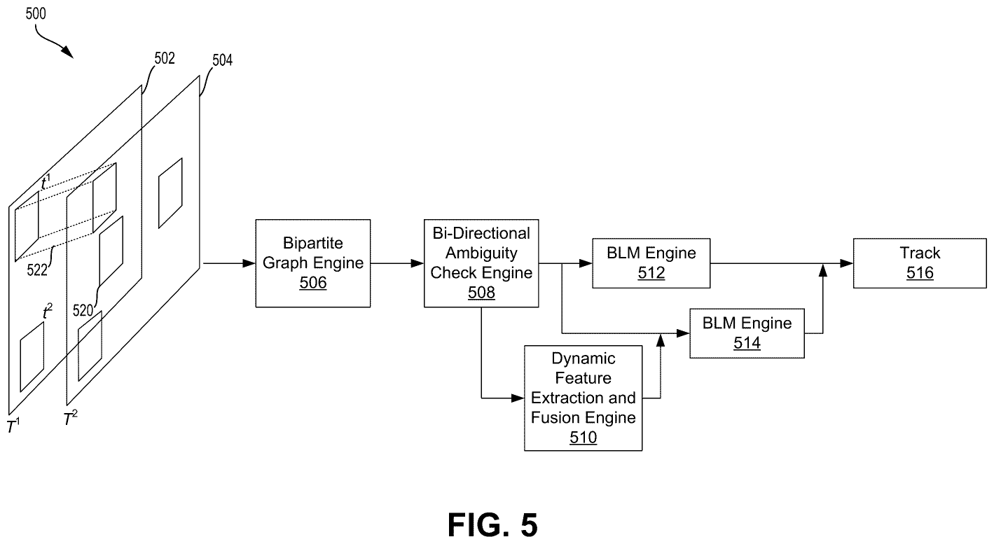

FIG. 5 is a block diagram illustrating a robust MOT with dynamic feature extraction and fusion by an object tracking system 500, in accordance with aspects of the present disclosure. As shown in FIG. 5, a first frame 502 may be received at time T¹ and a second frame 504 may be received at time T² (e.g., present time). Two objects may be detected and tracked in the first frame 502. In some cases, tracking may be initialized based on a detection score of the object. For example, an object detection algorithm may be executed for the first frame 502 and tracks (e.g., object tracks) initialized for objects having an object detection confidence score above a certain threshold score. Prior to association (e.g., after initialization and before association), the bounding boxes may not yet be associated with any specific object identifier. In some cases, an object that does not have an object detection confidence score above the threshold score (shown here as a dashed bounding box 520) may not be considered a detected object. After initialization, a detected object may be associated with an object identifier to help identify the object across frames. In the second frame 504, association with a previously tracked object may be performed and the second frame 504 may be received (e.g., from an object detection system by an object tracking system) along with bounding box information. For example, the object detection system may output the bounding box information along with information about associated previously tracked objects (e.g., in this example, information about three bounding boxes) to the object tracking system.

To determine whether to associate a particular bounding box with a previously detected/tracked object, the object tracking system 500 may include a bipartite graph engine 506 that may construct a bipartite graph (e.g., a matrix) using a predicted motion of a tracked object and a location of a bounding box. For example, motion may be predicted 522 based on how a previously tracked object moved. That predicted 522 motion, for an object, may indicate that the object may move from a first location in the first frame 502, to a second location in the second frame 504. The bipartite graph engine 506 may generate an indication of how well a particular bounding box matches with a predicted 522 motion of a previously tracked object. The bounding box information along with the indication of how well a bounding box matches with the predicted 522 motion may be passed to a bi-directional ambiguity check engine 508. Output from the bi-directional ambiguity check engine 508 may be passed to a dynamic feature extraction and fusion engine 510 as well as to a bipartite linear matching (BLM) engine 512. Output from the dynamic feature extraction and fusion engine 510 may be passed to another BLM engine 514 and output from BLM engine 514 may be merged with output from BLM engine 512 to generate a track 516 for the object.

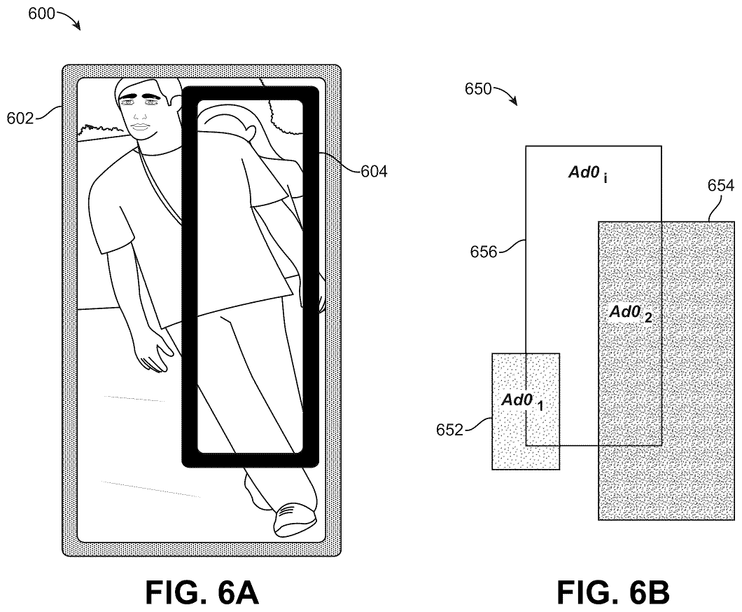

FIG. 6A is a conceptual diagram illustrating overlapping bounding boxes 600, in accordance with aspects of the present disclosure. In this example, a first person detected within a first bounding box (BB) 602 overlaps a second person detected within a second bounding box 604. FIG. 6B is an example of Adjacency Overlap (AdO) 650, in accordance with aspects of the present disclosure. In some cases, to address occlusion, an adjacency overlap (AdO) score may be determined for each detected object. As shown a first bounding box 652 may be associated with a first AdO score (AdO₁) may be determined for a, a second AdO score (AdO₂) may be determined for a second bounding box 654, and a third AdO score (AdOᵢ) may be determined for a third bounding box 656. In some cases, the AdO score(s) may be determined by the bi-directional ambiguity check engine 508 of FIG. 5. The AdO score may indicate whether an object (e.g., bounding box for the object) is overlapped/overlaps another object (e.g., bounding box for the other object). In some cases, the AdO may be determined for object i as

$${adj}_{o ( i , j )} = \frac{Intersection Area ( {BBs}_{i} , {BBs}_{j} )}{{BBs}_{i} area} ,$$

and AdOᵢ=Max (adj_{o(i,j)}), where j=(0, Number of objects in frame at time T²). The AdO score indicates an amount of the area of a bounding box for object i overlapping with a bounding box of another object. The maximum operation indicates a maximum amount of overlap (e.g., where object i is overlapped/overlaps multiple objects). In some cases, features may be extracted for objects with have an AdO below a threshold AdO score. In FIG. 6B, bounding box 656 may have an AdO (AdOᵢ) score below the threshold and features may be extracted for an object in bounding box 656, while bounding box 652 may not have an AdO (AdO₁) score below the threshold and features may not be extracted for objects in bounding box 652.

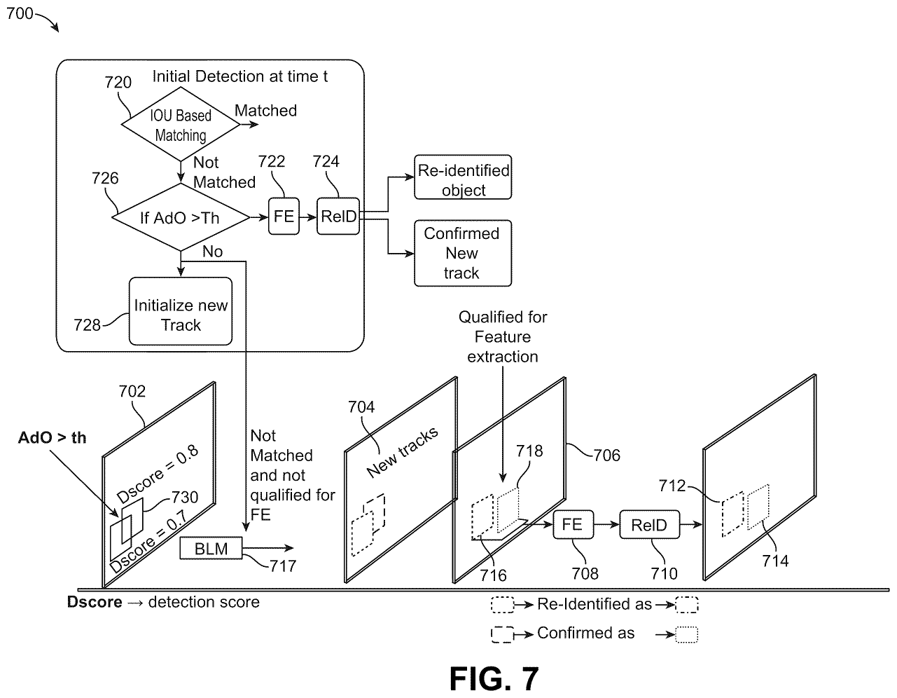

FIG. 7 is block diagram illustrating track initialization 700, in accordance with aspects of the present disclosure. In some examples, the track initialization 700 may be performed by a bi-directional ambiguity check engine 508 and/or dynamic feature extraction and fusion engine 510. In some cases, if a detected object is not matched (e.g., via IOU 720 matching) with an existing track or tracklet (e.g., where an object has been detected over a relatively small number of frames and a track for the object has not yet been fully determined), and is not qualified for feature extraction 722 and ReID 724 (e.g., if the AdO is greater than the threshold AdO score 726), a new track may be initialized 728. For example, a first frame 702 may include two detected objects 730, one occluding the other. In this example, the overlap between the two detected objects 730 may be such that the two detected objects 730 do not have an AdO score below the threshold AdO score 726 and thus may not be eligible for feature extraction 722. Additionally, the two detected objects 730 may not match with any previously tracked objects (e.g., in previous frames) based on IOU 720 matching. In some cases, matching with previously tracked objects may be performed based on extracted features (e.g., via ReID) and as the detected objects are not eligible for feature extraction due to their AdO scores, the two detected objects 730 may not be matched against previously tracked objects. New tracks 704 may be initialized for the two detected objects 730. In some cases, temporary object identifiers (IDs) may be assigned to the detected objects 730. In a later arriving second frame 706 the two detected objects may become eligible for feature extraction 708 (e.g., as the two objects have moved apart and are less (or no longer) overlapping, with an AdO less than the threshold AdO score 726). Feature extraction 708 may then be performed for the objects and the extracted features matched (e.g., via ReID 710 in this example) against features of previously tracked objects (e.g., from a track pool) to determine whether an object was previously tracked. If an object matches with a previously tracked object, then the object may be assigned the previous object ID from the previously tracked object. For example, a first object 712 of the two detected objects 730 may match a previously tracked object (e.g., from before the first frame 702, based on how similar features of a detected object match with features of a tracked object in the track pool) and the object ID may be updated accordingly as the first object 712 is reidentified. If the object does not match with a previously tracked object, the object may keep the newly assigned object ID as a new object to be tracked. For example, a second object 714 of the two detected objects may not match a previously tracked object and the temporary object ID retained.

In some cases, BLM 717 may be used to match a detected object using IOU 720 with a previous location of a previously tracked object. For example, if the IOU 720 indicates that a significant portion of the bounding box for the previously tracked object (such as object 716) overlaps with a new object to be tracked (such as object 718), then the new object 718 may be tentatively identified with the previously tracked object 716 and the identity of the new object 718 may be confirmed as being new based on the feature matching (e.g., via ReID 710).

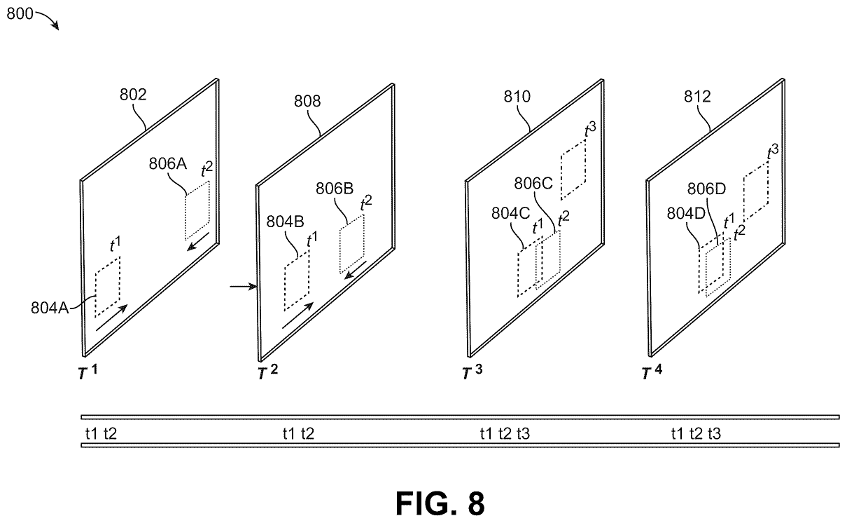

FIG. 8 is a block diagram illustrating association ambiguity 800, in accordance with aspects of the present disclosure. In some cases, it may be difficult to associate a detected object with a previously tracked above due to ambiguity, for example, from occlusion. As shown in FIG. 8, a first frame 802 at time T¹ may include two objects, a first object 804A and a second object 806A which may be moving toward each other, as shown in a second frame 808 at time T², where the first object 804B and second object 806B have moved toward each other. In some cases, based on how the first object 804A has moved between the first frame 802 and the second frame 808, a position of the first object 804B in the third frame 810 may be estimated and an IOU may be performed as between the estimated position and a detected object to determine that the detected object is the first object 804C. In some cases, such as between the first object 804D and second object 806D in the fourth frame 812, then IOU may not provide reliable results to identify which of multiple detected objects is the previously tracked object 804A, 804B, 804C. To determine whether there may be association ambiguity (e.g., by a bi-directional ambiguity check engine), a distance matrix may be determined based on IOU between a detected object and the estimated position of a tracked object and bidirectional checks (e.g., in both row-wise and column-wise directions checking each row/column) may be performed to determine whether there are multiple objects with a distance value less than a specified threshold to the estimated position. If multiple objects are detected in any single row/column less than the threshold distance away from the estimated position of a tracked object, then association ambiguity may be detected for those detected objects (e.g., as shown in the fourth frame 812 between the first object 804D and second object 806D). This threshold distance may be tunable and determined based on experimentation.

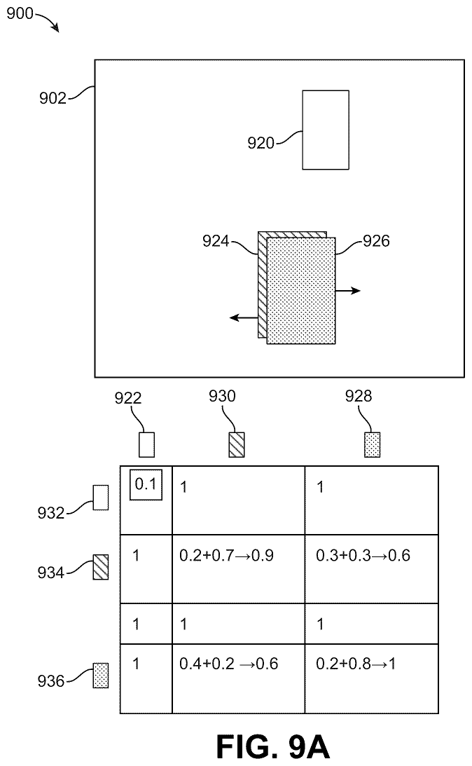

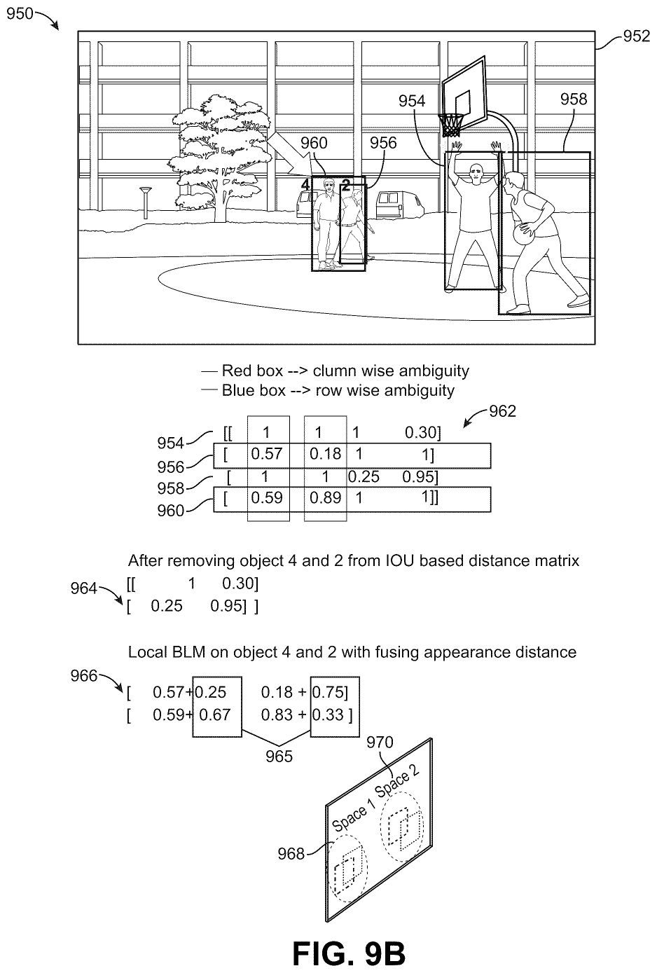

FIG. 9A illustrates a technique for dynamic feature extraction and fusion 900, in accordance with aspects of the present disclosure. In some cases, the image 902 shown in FIG. 8 may be similar to that shown in the fourth frame 812 of FIG. 8. In some cases, the technique for dynamic feature extraction and fusion 900 may be performed by a dynamic feature extraction and fusion engine, such as dynamic feature extraction and fusion engine 510 of FIG. 5. As indicated above, a distance matrix may be determined based on IOU between a detected object and the estimated position of a tracked object. As shown for a third detected object 920, which may be a stationary as between the third frame 810 and the fourth frame 812 of FIG. 8, the IOU distance 932A of the third detected object 920 and an estimated position 922 of the third object 932 (e.g., estimated from a previous frame) may be minimal (e.g., 0.1 in this example). As indicated above, the ambiguity check discussed above with respect to FIG. 8 may have indicated that a first detected object 924 and a second detected object 926 are both less than the threshold distance from an estimated position 928 of the first object 934 and an estimated position 930 of the second object 936. Of note, as discussed in the context of the first detected object 924 and the second detected object 926, at this point, the objects are detected objects that have not yet been associated with a tracked object. As the first detected object 924 is less than the threshold distance from the estimated position 930 of the second object 936, the IOU distance may be relatively small (e.g., 0.2 in this example), which may be difficult to distinguish from the IOU distance between the estimated position 928 of the first object 934 (e.g., 0.3 in this example). Similarly, as the second detected object 926 is less than the threshold distance from the estimated position 928 of the first object 934, the IOU distance may also be relatively small (e.g., 0.2 in this example) which may also be difficult to distinguish from the IOU distance between the estimated position 930 of the second object 936 (e.g., 0.4 in this example).

For objects having association ambiguity, a feature check may be performed. For the feature check, features of a detected object, such as the first detected object 924 may be obtained and compared to features of the tracked object (e.g., the first object). For example, ReID may be used to obtain and compare the features of the detected object to features of the tracked object (e.g., based on values in feature vectors). In some cases, the comparison may result in a similarity score indicating how closely the features match (e.g., a distance between the features). This similarly score may be combined with the IOU distance. In some cases, the similarly score may be combined with the IOU distance using any combining technique, such as summing, fusing, size/distance relative based combinations, etc. This combined score may then be used to associate a detected object, such as the first detected object 924 with a tracked object, such as the first object. In this example, as the first detected object 924 may have a lower combined score (e.g., less distance) with the estimated position 928 of the first object 934 (e.g., 0.6 in this example) as compared to the combined score with the estimated position 930 of the second object 936 (e.g., 0.9 in this example), the first detected object 924 may be associated with the first object 934.

In some cases, as the association ambiguity may be determined based on distances between a plurality of objects within an image, features may just be detected and compared for specific objects which are close together rather than for all objects in an image, allowing a local BLM to be performed, rather than global BLM. For example, feature extraction and comparisons between objects which are not within the threshold distance, such as the first detected object 924 and the estimated position 922 of the third object 932, may not be performed. Performing local BLN rather than global BLM can allow for lower computational costs, improved feature extraction, and potentially a higher matching accuracy.

FIG. 9B illustrates bi-directional ambiguity checks and dynamic feature extraction 950, in accordance with aspects of the present disclosure. As shown, frame 952 may include four detected objects, object 1 954, object 2 956, object 3, 958, and object 4 960. As shown, a distance matrix 962 may be generated indicating how much detected objects in frame 952 may overlap (e.g., IOU distances as between objects). A bi-directional ambiguity check, as discussed above with respect to FIG. 8, may be performed which may indicate that object 2 956 and object 4 960 are associated with multiple values in the horizontal or vertical direction in the distance matrix 962 which are less than a specified distance threshold from an estimated location of a tracked object. In some cases, objects identified by the bi-directional ambiguity check (e.g., object 2 956 and object 4 960) may be removed from the distance matrix 962, as shown in removed matrix 964. Association of the objects remaining in the removed matrix 964 with tracked objects may be performed. For the objects removed from the distance matrix 962, feature detection and comparison may be performed to determine how far 965 the detected objects appear from previously tracked objects (e.g., as shown in appearance distance matrix 966). This appearance distance may then be summed with the distance values removed from the distance matrix 962 as discussed above with respect to FIG. 9A.

In some cases, overlapping objects may be removed from the distance matrix 962 and considered separately based on which other objects a first object may have a low IOU distance value with. For example, object 2 956 may have IOU distance values below the distance threshold in column 1 (e.g., 0.57) and column 2 (e.g., 0.18) of the distance matrix 962, indicating that object 2 956 may be ambiguous with those two tracked objects (e.g., from column 1 and column 2). Feature detection/comparison/distances may then be determined separately for ambiguous objects in a first space 968 via local BLM as compared to objects that may be in a second space 970. This local BLM of detected objects which are ambiguous within a certain space (e.g., area of the frame) may improve performance as compared to global BLM of all detected objects in the frame.

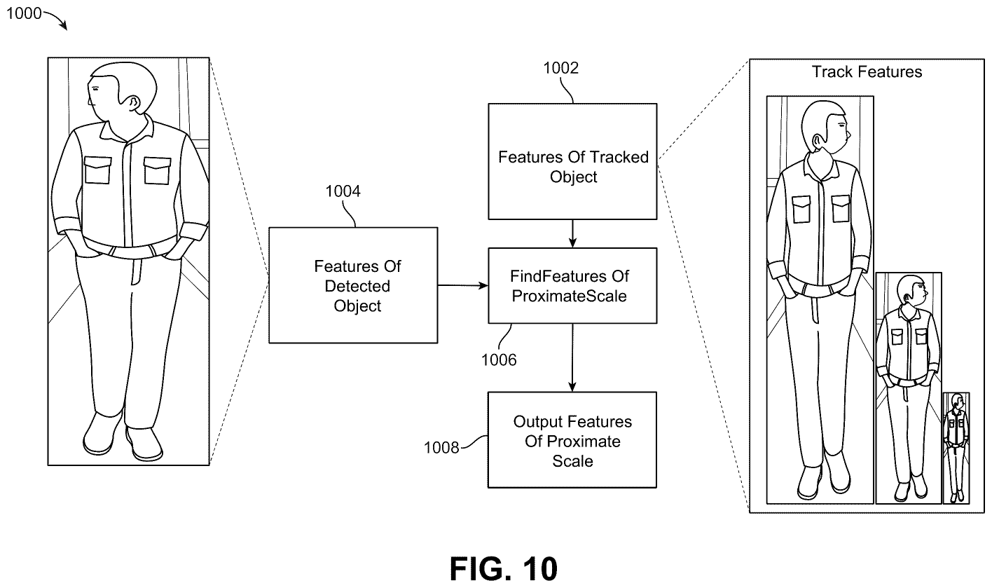

FIG. 10 illustrates scale guided feature similarity matching 1000, in accordance with aspect of the present disclosure. In some cases, multiple sets of features may be stored for tracked objects. For example, features for a tracked object may be stored at a first time, second time, third time, etc. Along with the features, a bounding box size may also be stored. In some cases, object detection may include a bounding box around a detected object. In some cases, features of a detected object may be compared to features of a previously tracked object (e.g., as described above with respect to FIGS. 9A and 9B). In such cases, the features of the tracked object with a bounding box that is closest in size to the bounding box around the detected object may be used. For example, features of tracked objects 1002 may be obtained (e.g., from a memory) along with features of a detected object 1004. The closest sized set of features of the tracked object may be found 1006 (e.g., based on bounding box size), and that set of features returned 1008. By using features of the tracked object closest in size, better feature comparison may be made as there may be less noise from, from example, different sized features being detected, rescaled, and/or compared.

In some cases, such as when performing object tracking on a network edge, computing resources may be relatively limited (e.g., as compared to a core network server). Due to such hardware constraints, a limited number of features may be extracted. In some cases, where a new track is created for a detected object, a higher priority may be assigned to extract features for the newly tracked object. This priority may be reduced after initial detection. The priority for feature extraction may then be increased the longer an object is tracked (e.g., over more frames). The priority for feature extraction may also be adjusted based on a time difference between a current time and the last feature extraction time (e.g., larger time differences may increase the priority, prioritized based on a number of frames (e.g., amount of time) an object has been tracked over). In some cases, a priority of features to extract may be adjusted on an object confidence score (e.g., confidence score from the object detection) or an AdO score (e.g., larger overlap may reduce priority for feature extraction).

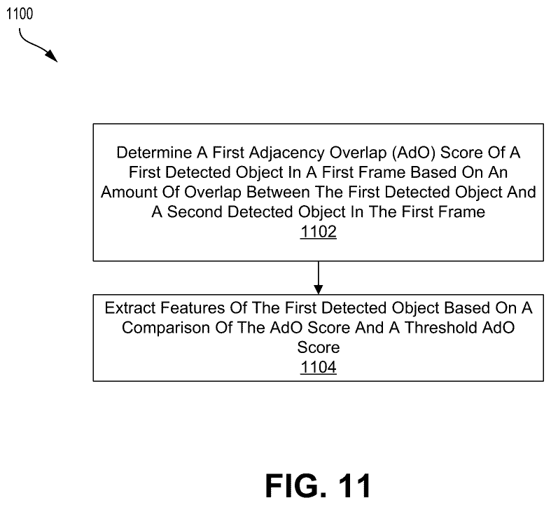

FIG. 11 is a flow diagram illustrating a process 1100 for object tracking, in accordance with aspects of the present disclosure. The process 1100 may be performed by a computing device (or apparatus, e.g., image capture and processing system 100 of FIG. 1, computing system 1200 of FIG. 12, etc.) or a component (e.g., a chipset, codec, processor 1210 of FIG. 12, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1100 may be implemented as software components that are executed and run on one or more processors.

At block 1102, the computing device (or component thereof) may determine (e.g., by a bi-directional ambiguity check engine 508 of FIG. 5) a first adjacency overlap (AdO) score of a first detected object in a first frame based on overlap between the first detected object and a second detected object in the first frame. In some cases, the AdO score may indicate whether an object is overlapped/overlaps another object.

At block 1104, the computing device (or component thereof) may extract (e.g., by a bi-directional ambiguity check engine 508 of FIG. 5) features of the first detected object based on a comparison of the AdO score and a threshold AdO score. In some cases, the computing device (or component thereof) may determine a second AdO score of the second detected object based on the overlap between the first detected object and a second detected object in the first frame; and determine not to extract features of the second detected object based on a comparison of the AdO score and a threshold AdO score. In some cases, the AdO score indicates an amount of area a bounding box of the first detected object overlaps with a bounding box of the second detected object. In some examples, the computing device (or component thereof) may compare (e.g., by a bi-directional ambiguity check engine 508 and/or dynamic feature extraction and fusion engine 510 of FIG. 5) a location of the second detected object with locations associated with a set of tracked objects from one or more previous frames; determine that the location of the second detected object does not match with the locations associated with the set of tracked objects based on a comparison with a distance threshold; and generate a new object identifier associated with the second detected object for tracking the second detected object. In some cases, the computing device (or component thereof) may determine to extract features of the second detected object for a second frame; and determine that the second detected object is a new object based on a comparison of the extracted features of the second detected object with a set of features associated with the set of tracked objects. In some examples, the computing device (or component thereof) may determine distances between a third detected object in the first frame and predicted locations of tracked objects of a set of tracked objects; determine that the third detected object is within a distance threshold of a predicted location of a first tracked object and a predicted location of a second tracked object; and perform feature extraction for the third detected object based on the determination that the third detected object is within the distance threshold of the predicted location of the first tracked object and the predicted location of the second tracked object. In some cases, the distances between the third detected object and predicted locations of the tracked objects is determined based on an intersection over union (IOU) comparison. In some examples, the computing device (or component thereof) may determine whether the third detected object is associated with the first tracked object or second tracked object based on the extracted features, a first distance to the predicted location of the first tracked object and a second distance to the predicted location of the second tracked object. In some cases, the computing device (or component thereof) may determine whether the third detected object is associated with the first tracked object or second tracked object by determining a third distance between features of the third detected object and features of the first tracked object; determining a fourth distance between features of the third detected object and features of the second tracked object; combining the first distance with the third distance and the second distance with the fourth distance; and determining whether the third detected object is associated with the first tracked object or second tracked object based on a comparison of the combined distances. In some examples, the computing device (or component thereof) may combine the first distance with the third distance and the second distance with the fourth distance by summing the first distance with the third distance and summing the second distance with the fourth distance. In some cases, the computing device (or component thereof) may select a set of features from the features of first tracked object based on a size of a bounding box of the third detected object and a size associated with the set of features from the features of first tracked object. In some examples, the computing device (or component thereof) may determine distances between a fourth detected object in the first frame and predicted location of tracked objects of the set of tracked objects; determine that the fourth detected object is not within a distance threshold of a predicted location of another tracked object; and determine not to perform feature extraction for the fourth detected object based on the determination that the third detected object is not within the distance threshold of the predicted location of another tracked object. In some cases, the computing device (or component thereof) may determine distances between a fourth detected object in the first frame and predicted location of tracked objects of the set of tracked objects; determine distances between a fifth detected object in the first frame and predicted location of tracked objects of the set of tracked objects; determine that the fourth detected object and fifth detected object are not within a distance threshold of the predicted location of a first tracked object and the predicted location of a second tracked object; determine that the fourth detected object and fifth detected object are within a distance threshold of a predicted location of a third tracked object and a predicted location of a fourth tracked object; perform feature extraction for the fourth detected object and fifth detected object based on the determination that the fourth detected object and fifth detected object are within a distance threshold of the predicted location of a third tracked object and the predicted location of a fourth tracked object; and compare the extracted features of the fourth detected object and fifth detected object with features associated with the third tracked object and the fourth tracked object without comparing the extracted features of the fourth detected object and fifth detected object with features associated with the first tracked object and second tracked object. In some examples, the computing device (or component thereof) may determine distances between a third detected object in the first frame and predicted locations of tracked objects of a set of tracked objects; determine that the third detected object is within a distance threshold of a predicted location of one of the tracked objects; and associate the third detected object with the one tracked object without performing feature extraction for the third detected object. In some cases, the computing device (or component thereof) may create a new track for the first detected object based on a location of the first detected object with locations associated with a set of tracked objects from one or more previous frames, wherein a number of tracked objects are limited, and wherein the first detected object is tracked at a higher priority as compared to another tracked object. In some examples, the tracked objects are prioritized based on a number of frames a tracked object has been detected in.

In some examples, the processes described herein (e.g., process 1100 and/or other process described herein) may be performed by the image capture and processing system 100 of FIG. 1.

In some cases, the devices or apparatuses configured to perform the operations of the process 1100 and/or other processes described herein may include a processor, microprocessor, micro-computer, or other component of a device that is configured to carry out the steps of the process 1100 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 1100 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1100 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

FIG. 12 is a diagram illustrating an example of a system for implementing certain aspects of the present technology. In particular, FIG. 12 illustrates an example of computing system 1200, which may be for example any computing device making up internal computing system, a remote computing system, a camera, or any component thereof in which the components of the system are in communication with each other using connection 1205. Connection 1205 may be a physical connection using a bus, or a direct connection into processor 1210, such as in a chipset architecture. Connection 1205 may also be a virtual connection, networked connection, or logical connection.

In some embodiments, computing system 1200 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 may include a cache 1212 of high-speed memory connected directly with, in close proximity to, or integrated as part of processor 1210.

Processor 1210 may include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which may represent any number of input mechanisms, such as a microphone for speech, a touch-sensitive screen for gesture or graphical input, keyboard, mouse, motion input, speech, etc. Computing system 1200 may also include output device 1235, which may be one or more of a number of output mechanisms. In some instances, multimodal systems may enable a user to provide multiple types of input/output to communicate with computing system 1200.

Computing system 1200 may include communications interface 1240, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1230 may include software services, servers, services, etc., that when the code that defines such software is executed by the processor 1210, it causes the system to perform a function. In some embodiments, a hardware service that performs a particular function may include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“ ”) and greater than or equal to (“ ”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for shape estimation, comprising: at least one memory; and at least one processor coupled to the at least one memory and configured to: determine a first adjacency overlap (AdO) score of a first detected object in a first frame based on overlap between the first detected object and a second detected object in the first frame; and extract features of the first detected object based on a comparison of the AdO score and a threshold AdO score.

Aspect 2. The apparatus of Aspect 1, wherein the at least one processor is further configured to: determine a second AdO score of the second detected object based on the overlap between the first detected object and a second detected object in the first frame; and determine not to extract features of the second detected object based on a comparison of the AdO score and a threshold AdO score.

Aspect 3. The apparatus of Aspect 2, wherein the at least one processor is further configured to: compare a location of the second detected object with locations associated with a set of tracked objects from one or more previous frames; determine that the location of the second detected object does not match with the locations associated with the set of tracked objects based on a comparison with a distance threshold; and generate a new object identifier associated with the second detected object for tracking the second detected object.

Aspect 4. The apparatus of Aspect 3, wherein the at least one processor is further configured to: determine to extract features of the second detected object for a second frame; and determine that the second detected object is a new object based on a comparison of the extracted features of the second detected object with a set of features associated with the set of tracked objects.

Aspect 5. The apparatus of any of Aspects 1-4, wherein the AdO score indicates an amount of area a bounding box of the first detected object overlaps with a bounding box of the second detected object.

Aspect 6. The apparatus of any of Aspects 1-5, wherein the at least one processor is further configured to: determine distances between a third detected object in the first frame and predicted locations of tracked objects of a set of tracked objects; determine that the third detected object is within a distance threshold of a predicted location of a first tracked object and a predicted location of a second tracked object; and perform feature extraction for the third detected object based on the determination that the third detected object is within the distance threshold of the predicted location of the first tracked object and the predicted location of the second tracked object.

Aspect 7. The apparatus of Aspect 6, wherein the distances between the third detected object and predicted locations of the tracked objects is determined based on an intersection over union (IOU) comparison.

Aspect 8. The apparatus of any of Aspects 6-7, wherein the at least one processor is further configured to: determine whether the third detected object is associated with the first tracked object or second tracked object based on the extracted features, a first distance to the predicted location of the first tracked object and a second distance to the predicted location of the second tracked object.

Aspect 9. The apparatus of Aspect 8, wherein, to determine whether the third detected object is associated with the first tracked object or second tracked object, the at least one processor is further configured to: determine a third distance between features of the third detected object and features of the first tracked object; determine a fourth distance between features of the third detected object and features of the second tracked object; combine the first distance with the third distance and the second distance with the fourth distance; and determine whether the third detected object is associated with the first tracked object or second tracked object based on a comparison of the combined distances.

Aspect 10. The apparatus of Aspect 9, wherein, to combine the first distance with the third distance and the second distance with the fourth distance, the at least one processor is configured to sum the first distance with the third distance and sum the second distance with the fourth distance.

Aspect 11. The apparatus of any of Aspects 9-10, wherein the at least one processor is configured to select a set of features from the features of first tracked object based on a size of a bounding box of the third detected object and a size associated with the set of features from the features of first tracked object.

Aspect 12. The apparatus of any of Aspects 6-11, wherein the at least one processor is further configured to: determine distances between a fourth detected object in the first frame and predicted location of tracked objects of the set of tracked objects; determine that the fourth detected object is not within a distance threshold of a predicted location of another tracked object; and determine not to perform feature extraction for the fourth detected object based on the determination that the third detected object is not within the distance threshold of the predicted location of another tracked object.

Aspect 13. The apparatus of any of Aspects 6-12, wherein the at least one processor is further configured to: determine distances between a fourth detected object in the first frame and predicted location of tracked objects of the set of tracked objects; determine distances between a fifth detected object in the first frame and predicted location of tracked objects of the set of tracked objects; determine that the fourth detected object and fifth detected object are not within a distance threshold of the predicted location of a first tracked object and the predicted location of a second tracked object; determine that the fourth detected object and fifth detected object are within a distance threshold of a predicted location of a third tracked object and a predicted location of a fourth tracked object; perform feature extraction for the fourth detected object and fifth detected object based on the determination that the fourth detected object and fifth detected object are within a distance threshold of the predicted location of a third tracked object and the predicted location of a fourth tracked object; and compare the extracted features of the fourth detected object and fifth detected object with features associated with the third tracked object and the fourth tracked object without comparing the extracted features of the fourth detected object and fifth detected object with features associated with the first tracked object and second tracked object.

Aspect 14. The apparatus of any of Aspects 1-13, wherein the at least one processor is further configured to: determine distances between a third detected object in the first frame and predicted locations of tracked objects of a set of tracked objects; determine that the third detected object is within a distance threshold of a predicted location of one of the tracked objects; and associate the third detected object with the one tracked object without performing feature extraction for the third detected object.

Aspect 15. The apparatus of any of Aspects 1-14, wherein the at least one processor is further configured to: create a new track for the first detected object based on a location of the first detected object with locations associated with a set of tracked objects from one or more previous frames, wherein a number of tracked objects are limited, and wherein the first detected object is tracked at a higher priority as compared to another tracked object.

Aspect 16. The apparatus of Aspect 15, wherein tracked objects are prioritized based on a number of frames a tracked object has been detected in.

Aspect 17. A method for shape estimation, comprising: determining a first adjacency overlap (AdO) score of a first detected object in a first frame based on overlap between the first detected object and a second detected object in the first frame; and extracting features of the first detected object based on a comparison of the AdO score and a threshold AdO score.

Aspect 18. The method of Aspect 17, further comprising: determining a second AdO score of the second detected object based on the overlap between the first detected object and a second detected object in the first frame; and determining not to extract features of the second detected object based on a comparison of the AdO score and a threshold AdO score.

Aspect 19. The method of Aspect 18, further comprising: comparing a location of the second detected object with locations associated with a set of tracked objects from one or more previous frames; determining that the location of the second detected object does not match with the locations associated with the set of tracked objects based on a comparison with a distance threshold; and generating a new object identifier associated with the second detected object for tracking the second detected object.

Aspect 20. The method of Aspect 19, further comprising: determining to extract features of the second detected object for a second frame; and determining that the second detected object is a new object based on a comparison of the extracted features of the second detected object with a set of features associated with the set of tracked objects.

Aspect 21. The method of any of Aspects 17-20, wherein the AdO score indicates an amount of area a bounding box of the first detected object overlaps with a bounding box of the second detected object.

Aspect 22. The method of any of Aspects 17-21, further comprising: determining distances between a third detected object in the first frame and predicted locations of tracked objects of a set of tracked objects; determining that the third detected object is within a distance threshold of a predicted location of a first tracked object and a predicted location of a second tracked object; and performing feature extraction for the third detected object based on the determination that the third detected object is within the distance threshold of the predicted location of the first tracked object and the predicted location of the second tracked object.

Aspect 23. The method of Aspect 22, wherein the distances between the third detected object and predicted locations of the tracked objects is determined based on an intersection over union (IOU) comparison.

Aspect 24. The method of any of Aspects 22-23, further comprising: determining whether the third detected object is associated with the first tracked object or second tracked object based on the extracted features, a first distance to the predicted location of the first tracked object and a second distance to the predicted location of the second tracked object.

Aspect 25. The method of Aspect 24, wherein determining whether the third detected object is associated with the first tracked object or second tracked object comprises: determining a third distance between features of the third detected object and features of the first tracked object; determining a fourth distance between features of the third detected object and features of the second tracked object; combining the first distance with the third distance and the second distance with the fourth distance; and determining whether the third detected object is associated with the first tracked object or second tracked object based on a comparison of the combined distances.

Aspect 26. The method of Aspect 25, wherein combining the first distance with the third distance and the second distance with the fourth distance comprises summing the first distance with the third distance and sum the second distance with the fourth distance.

Aspect 27. The method of any of Aspects 25-26, further comprising selecting a set of features from the features of first tracked object based on a size of a bounding box of the third detected object and a size associated with the set of features from the features of first tracked object.

Aspect 28. The method of any of Aspects 22-27, further comprising: determining distances between a fourth detected object in the first frame and predicted location of tracked objects of the set of tracked objects; determining that the fourth detected object is not within a distance threshold of a predicted location of another tracked object; and determining not to perform feature extraction for the fourth detected object based on the determination that the third detected object is not within the distance threshold of the predicted location of another tracked object.

Aspect 29. The method of any of Aspects 22-28, further comprising: determining distances between a fourth detected object in the first frame and predicted location of tracked objects of the set of tracked objects; determining distances between a fifth detected object in the first frame and predicted location of tracked objects of the set of tracked objects; determining that the fourth detected object and fifth detected object are not within a distance threshold of the predicted location of a first tracked object and the predicted location of a second tracked object; determining that the fourth detected object and fifth detected object are within a distance threshold of a predicted location of a third tracked object and a predicted location of a fourth tracked object; performing feature extraction for the fourth detected object and fifth detected object based on the determination that the fourth detected object and fifth detected object are within a distance threshold of the predicted location of a third tracked object and the predicted location of a fourth tracked object; and comparing the extracted features of the fourth detected object and fifth detected object with features associated with the third tracked object and the fourth tracked object without comparing the extracted features of the fourth detected object and fifth detected object with features associated with the first tracked object and second tracked object.

Aspect 30. The method of any of Aspects 17-29, further comprising: determining distances between a third detected object in the first frame and predicted locations of tracked objects of a set of tracked objects; determining that the third detected object is within a distance threshold of a predicted location of one of the tracked objects; and associating the third detected object with the one tracked object without performing feature extraction for the third detected object.

Aspect 31. The method of any of Aspects 17-30, further comprising: creating a new track for the first detected object based on a location of the first detected object with locations associated with a set of tracked objects from one or more previous frames, wherein a number of tracked objects are limited, and wherein the first detected object is tracked at a higher priority as compared to another tracked object.

Aspect 32. The method of Aspect 31, wherein tracked objects are prioritized based on a number of frames a tracked object has been detected in.

Aspect 33. A non-transitory computer-readable medium having stored thereon instructions that, when executed by at least one processor, cause the at least one processor to perform operations according to any of Aspects 17-32.

Aspect 34. An apparatus for shape estimation comprising one or more means for performing operations according to any of Aspects 17-32.

What is claimed is:

1. An apparatus for shape estimation, comprising:
at least one memory; and
at least one processor coupled to the at least one memory and configured to:
determine a first adjacency overlap (AdO) score of a first detected object in a first frame based on overlap between the first detected object and a second detected object in the first frame; and
extract features of the first detected object based on a comparison of the AdO score and a threshold AdO score.

2. The apparatus of claim 1, wherein the at least one processor is further configured to:
determine a second AdO score of the second detected object based on the overlap between the first detected object and a second detected object in the first frame; and
determine not to extract features of the second detected object based on a comparison of the AdO score and a threshold AdO score.

3. The apparatus of claim 2, wherein the at least one processor is further configured to:
compare a location of the second detected object with locations associated with a set of tracked objects from one or more previous frames;
determine that the location of the second detected object does not match with the locations associated with the set of tracked objects based on a comparison with a distance threshold; and
generate a new object identifier associated with the second detected object for tracking the second detected object.

4. The apparatus of claim 3, wherein the at least one processor is further configured to:
determine to extract features of the second detected object for a second frame; and
determine that the second detected object is a new object based on a comparison of the extracted features of the second detected object with a set of features associated with the set of tracked objects.

5. The apparatus of claim 1, wherein the AdO score indicates an amount of area a bounding box of the first detected object overlaps with a bounding box of the second detected object.

6. The apparatus of claim 1, wherein the at least one processor is further configured to:
determine distances between a third detected object in the first frame and predicted locations of tracked objects of a set of tracked objects;
determine that the third detected object is within a distance threshold of a predicted location of a first tracked object and a predicted location of a second tracked object; and
perform feature extraction for the third detected object based on the determination that the third detected object is within the distance threshold of the predicted location of the first tracked object and the predicted location of the second tracked object.

7. The apparatus of claim 6, wherein the distances between the third detected object and predicted locations of the tracked objects is determined based on an intersection over union (IOU) comparison.

8. The apparatus of claim 6, wherein the at least one processor is further configured to:
determine whether the third detected object is associated with the first tracked object or second tracked object based on the extracted features, a first distance to the predicted location of the first tracked object and a second distance to the predicted location of the second tracked object.

9. The apparatus of claim 8, wherein, to determine whether the third detected object is associated with the first tracked object or second tracked object, the at least one processor is further configured to:
determine a third distance between features of the third detected object and features of the first tracked object;
determine a fourth distance between features of the third detected object and features of the second tracked object;
combine the first distance with the third distance and the second distance with the fourth distance; and
determine whether the third detected object is associated with the first tracked object or second tracked object based on a comparison of the combined distances.

10. The apparatus of claim 9, wherein, to combine the first distance with the third distance and the second distance with the fourth distance, the at least one processor is configured to sum the first distance with the third distance and sum the second distance with the fourth distance.

11. The apparatus of claim 9, wherein the at least one processor is configured to select a set of features from the features of first tracked object based on a size of a bounding box of the third detected object and a size associated with the set of features from the features of first tracked object.

12. The apparatus of claim 6, wherein the at least one processor is further configured to:
determine distances between a fourth detected object in the first frame and predicted location of tracked objects of the set of tracked objects;
determine that the fourth detected object is not within a distance threshold of a predicted location of another tracked object; and
determine not to perform feature extraction for the fourth detected object based on the determination that the third detected object is not within the distance threshold of the predicted location of another tracked object.

13. The apparatus of claim 6, wherein the at least one processor is further configured to:
determine distances between a fourth detected object in the first frame and predicted location of tracked objects of the set of tracked objects;
determine distances between a fifth detected object in the first frame and predicted location of tracked objects of the set of tracked objects;
determine that the fourth detected object and fifth detected object are not within a distance threshold of the predicted location of a first tracked object and the predicted location of a second tracked object;
determine that the fourth detected object and fifth detected object are within a distance threshold of a predicted location of a third tracked object and a predicted location of a fourth tracked object;
perform feature extraction for the fourth detected object and fifth detected object based on the determination that the fourth detected object and fifth detected object are within a distance threshold of the predicted location of a third tracked object and the predicted location of a fourth tracked object; and
compare the extracted features of the fourth detected object and fifth detected object with features associated with the third tracked object and the fourth tracked object without comparing the extracted features of the fourth detected object and fifth detected object with features associated with the first tracked object and second tracked object.

14. The apparatus of claim 1, wherein the at least one processor is further configured to:
determine distances between a third detected object in the first frame and predicted locations of tracked objects of a set of tracked objects;
determine that the third detected object is within a distance threshold of a predicted location of one of the tracked objects; and
associate the third detected object with the one tracked object without performing feature extraction for the third detected object.

15. The apparatus of claim 1, wherein the at least one processor is further configured to:
create a new track for the first detected object based on a location of the first detected object with locations associated with a set of tracked objects from one or more previous frames, wherein a number of tracked objects are limited, and wherein the first detected object is tracked at a higher priority as compared to another tracked object.

16. The apparatus of claim 15, wherein tracked objects are prioritized based on a number of frames a tracked object has been detected in.

17. A method for shape estimation, comprising:
determining a first adjacency overlap (AdO) score of a first detected object in a first frame based on overlap between the first detected object and a second detected object in the first frame; and
extracting features of the first detected object based on a comparison of the AdO score and a threshold AdO score.

18. The method of claim 17, further comprising:
determining a second AdO score of the second detected object based on the overlap between the first detected object and a second detected object in the first frame; and
determining not to extract features of the second detected object based on a comparison of the AdO score and a threshold AdO score.

19. The method of claim 18, further comprising:
comparing a location of the second detected object with locations associated with a set of tracked objects from one or more previous frames;
determining that the location of the second detected object does not match with the locations associated with the set of tracked objects based on a comparison with a distance threshold; and
generating a new object identifier associated with the second detected object for tracking the second detected object.

20. The method of claim 19, further comprising:
determining to extract features of the second detected object for a second frame; and
determining that the second detected object is a new object based on a comparison of the extracted features of the second detected object with a set of features associated with the set of tracked objects.
